(19) United States
(12) Patent Application Publication
(10) Pub. No.: US 2013/0162816 A1
(43) Pub. Date: Jun. 27, 2013

(54) DEVICE FOR MEASURING THE SHAPE OF A MIRROR OR OF A SPECULAR SURFACE

(71) Applicants: Michel Pichon, Gouvieux (FR); Romain Etienne, Compiegne (FR); Alexandre Marlier, Pontoise les Noyoi (FR)

(72) Inventors: Michel Pichon, Gouvieux (FR); Romain Etienne, Compiegne (FR); Alexandre Marlier, Pontoise les Noyoi (FR)

(73) Assignee: SAINT-GOBAIN GLASS FRANCE, Courbevoie (FR)

(21) Appl. No.: 13/820,198

(22) PCT Filed: Sep. 14, 2011
(86) PCT No.: PCT/FR2011/052100

§ 371 Date: Mar. 1, 2013

(30) Foreign Application Priority Data
Sep. 17, 2010 (FR) 1057466

(51) Int. Cl. H04N 7/18

(52) U.S. Cl. CPC H04N 7/18
USPC 348/137

(57) ABSTRACT

A device for measuring a shape of a surface. The device includes a first monodirectional-pattern gauge illuminated by first lighting mechanism, thereby making it possible to measure the shape in relation to a first direction, and a second gauge with monodirectional pattern perpendicular to the pattern of the first gauge making it possible to measure the shape in relation to a second direction perpendicular to the first direction. The second gauge is produced in the same plane as the first gauge by an additional lighting mechanism that is only turned on when the first lighting mechanism is turned off.

The invention relates to a device for measuring the shape of a mirror or of a specular surface (reflecting surface).

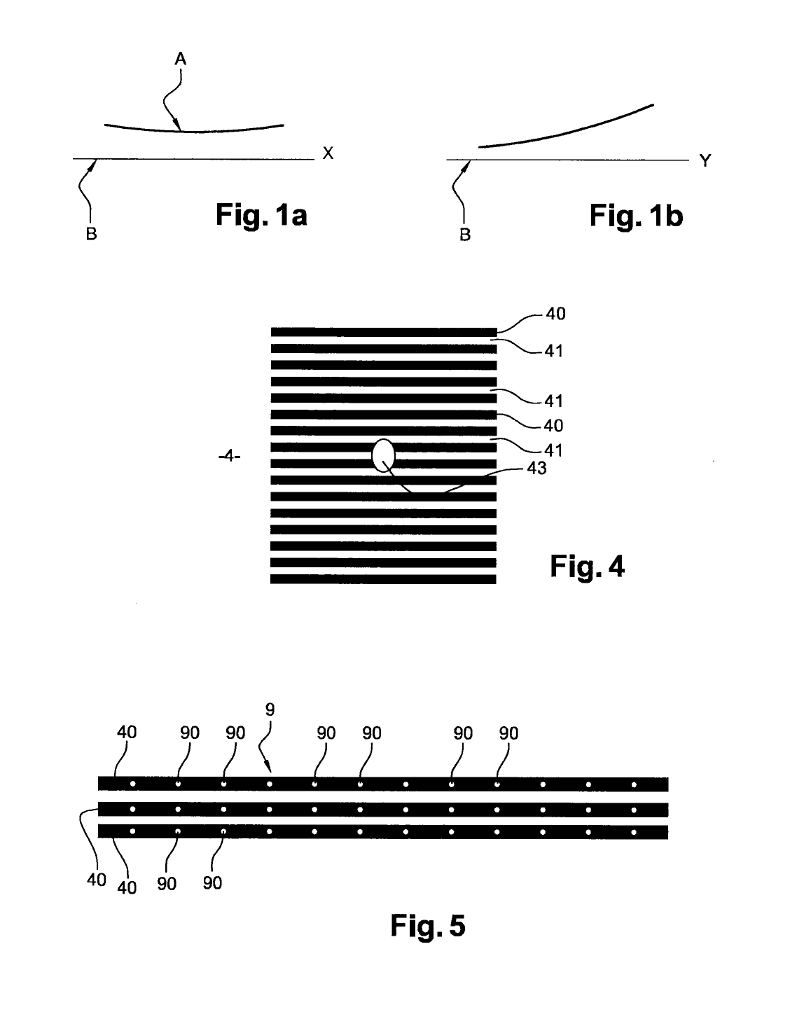

The invention is more particularly intended for surfaces which are not plane but exhibit a cambered shape whose concavity is strongly marked in relation to one direction, subsequently termed the “principal direction”, and appreciably less marked in the direction perpendicular to the principal direction, termed the “secondary direction”. More precisely, “the direction of a concavity” is understood thus and such as illustrated in FIGS. 1a and 1b: when positioning a surface A on a horizontal plane support B with the cambered part facing this support, the concavity with respect to the plane of the support turns out to be different in relation to its comparison with respect to said plane in one and the other of the directions of the plane, directions corresponding to the X and Y axes in a two-dimensional orthogonal reference frame of the plane. The concavity that is most pronounced with respect to the other is that which is the least parallel to the support plane. By way of example in FIGS. 1a and 1b, the concavity is more pronounced in relation to the X axis, consequently termed the principal direction, than in relation to the Y axis, termed the secondary direction.

Moreover, the expression “measuring the shape” is understood to mean estimating the slope and altitude for a multitude of points of the surface to be measured with respect to a reference surface, doing so in the two directions of measurement corresponding to the principal and secondary directions of the camber.

The invention will be more particularly described with regard to a cambered glazing, without however being limited thereto. The device also applies to very slightly deformed plane surfaces, be they made of laminated glass or tempered glass. Another useful application of the device relates to the shape measurement of parabolic solar mirrors, for which the concavity of the surface is much more accentuated.

Depending on the applications, it is indeed opportune to measure the shape of a specular surface, for example so as to detect defects of the glass at the level of the outside surface of an automobile glazing. Detection and measurement of these defects make it possible to provide the esthetic rendition of the automobile glazing if the latter were observed in reflection from outside the motor vehicle with which it is associated. Moreover, certain defects may even become very troublesome after assembly of the glass sheet in order to construct a laminated glazing used as a windshield, since they give rise to optical distortion phenomena, accentuated on account of assembly with a second glass sheet. Consequently, in practice, it is desired to detect these defects well upstream in a glazing manufacturing plant so as to discard and scrap these glass surfaces in the case of overly pronounced defects.

It is also judicious to ascertain the shape of a glazing so as to know whether its periphery will perfectly match the bodywork for which it is intended.

In a parabolic mirror application, it is generally preferable to ascertain the shape of the mirror just after its manufacture, by comparing it with the perfect shape of a reference mirror. Indeed, the energy efficiency of a mirror depends on the good focusing of the light rays by this mirror. Now, the focusing is directly related to the apt profile of the concavity of the mirror, which profile is precisely assessed by measuring the slope and altitude of a multitude of points of the surface.

Various shape measurement techniques are known, such as the feeler-based method, photogrammetry, deflectometry, or else laser scanning.

The feeler-based method consists in mounting a feeler at the end of a mechanical arm coming into contact with the surface of the glazing at numerous points (typically 1000 regularly distributed points for a glazing of 1500×1500 mm). This measurement device affords access directly to the altitude of each of the points. The local slope is thereafter calculated on the basis of the altitude by numerical differentiation. The duration of acquisition and processing is of the order of 100 minutes.

Photogrammetry consists in sticking over the whole of the surface to be measured a gauge consisting of a white sheet on which is traced a large number of precisely positioned black points. Several photographs of this gauge are taken from various angles (typically eight angles), and then these photographs are processed by appropriate software so as to reconstruct the shape in two dimensions of the surface and thus provide a mapping of the altitude. The local slope is calculated on the basis of this altitude by differentiation. The duration of acquisition and processing is of the order of 120 minutes.

However, the two previous techniques exhibit the drawback of excessively long processing times when they are required to be implemented on industrial lines whose speeds impose the passage of a volume every 20 to 30 seconds.

The deflectometry technique is on the other hand much faster, of the order of 5 minutes. It consists in analyzing the deformations of a gauge after reflection on the surface to be measured. By ascertaining the state of the undeformed gauge, and in a known manner based on ray tracing, the local slope of the surface at any point of this surface may be calculated. Mathematical integration of the local slope at consecutive points leads to the altitude of these various points.

Laser scanning, a technique which is also faster, consists in scanning the surface to be analyzed along two perpendicular directions with a laser precisely aligned along each of the directions. A camera observes the point of impact of the beam after reflection on a target placed in the plane of focusing of the surface and verifies the quality of the centering of the point of impact of the beam on this target. The duration of the measurement, for a surface with an area of 1500×1500 mm is, typically, 5 minutes.

However, the deflectometry and laser scanning techniques are difficult to implement on an industrial line since they require extremely fine adjustments, positionings or calibrations of the measurement systems when a new surface has to be measured. In particular, an error in alignment or inclination of the laser, for example of 1 milliradian, i.e. 1 mm over a distance of 1 m, totally falsifies the results of the measurement and estimation.

The aim of the invention is therefore to provide a device for measuring the shape of a specular surface associated with a volume such as a glazing or a mirror, this device not exhibiting the aforementioned drawbacks and allying the performance both as regards implementation time and data acquisition and processing time, and reproducibility of measurement on an industrial line.

According to the invention, the device for measuring the shape of a mirror or of a specular surface comprises a first monodirectional-pattern plane gauge intended to be some distance from the surface to be measured, a camera for photographing the image intended to be reflected in the specular surface, means for processing the information recorded by the camera, first means of lighting of the whole gauge, and is characterized in that it comprises additional lighting means which are arranged, in immediate proximity and parallel to the plane of the gauge, or in the actual plane of the gauge, and facing the surface to be measured, the first lighting means and the additional ones illuminating alternately so as to view respectively only the first gauge or else a second monodirectional-pattern gauge produced on the basis of the additional lighting means.

The additional lighting means by their arrangement are intended to illuminate in the plane of the gauge in the direction of the surface to be measured.

The device therefore makes it possible on the basis of two different gauges to provide measurements at one and the same time, in the direction of the surface which invokes the highest precision and resolution, namely the direction of greater deformation, and in the secondary direction perpendicular to the principal direction.

Thus, the alternated lighting reveals either a first monodirectional-pattern gauge which ensures measurement of the shape in the principal direction, or a second gauge with monodirectional pattern and perpendicular to the pattern of the first gauge so as to measure the deformation of the surface in its secondary direction.

This device avoids the use of a gauge with bidirectional pattern, such as a gauge in the form of a checkerboard, which is difficult to process and exhibits too low a spatial resolution. The device of the invention consequently circumvents these difficulties by having two different gauges coexist on the same surface supporting the first gauge, said two different gauges being visible only according to an appropriate implementation of the lighting conditions.

According to one characteristic, the lighting time respectively of the first lighting means and of the additional lighting means lasts the time required by the camera to take a respective photograph of the whole of the surface.

Thus, this device allows extremely fast measurement of the shape of the surface according to an acquisition and processing time of at most 20 seconds, this being particularly adapted for an industrial line.

According to another characteristic, the first gauge comprises an alternation of dark and bright parallel lines of identical width, such as 10 mm. The “width” of a line is understood to mean its smallest dimension.

Preferably, the second gauge provided by the additional lighting means comprises a multiplicity of point light sources, of the light-emitting diode or optical fiber termination type, which are regularly spaced according to an alignment parallel to the lines of the first gauge.

More particularly, the light sources are aligned in a manner centered in the width of at least one dark line.

According to another characteristic, the device comprises a panel carrying the first gauge, this panel comprising a central orifice which accommodates the objective of the camera, preferably the orifice being dimensioned so that the ratio of its area to the total area of the gauge is less than 1/1000.

The distance between the first gauge and the surface to be measured, and the dimensions of the gauge are adapted so that the whole of the gauge is reflected on the entirety of the surface to be measured, and in that the objective of the camera is adapted for recording in a single photograph the entirety of the surface to be measured.

The device is advantageously associated with a plane support carrying the surface to be measured, this support extending parallel to the first gauge, and the surface to be measured being intended to be arranged in a centered manner with respect to the optical axis of the objective of the camera. The opposite edges of the surface to be measured, which are perpendicular to the principal direction, are placed substantially at the same distance from the support so that the curvature in the principal direction is substantially symmetric with respect to the optical axis constituted by the axis of the camera.

To ensure the measurement according to the principal and secondary directions of a cambered surface, the concavity of said surface must be directed toward the gauge, and said surface is arranged on said support in such a way that the monodirectional pattern of the first gauge is oriented perpendicularly to the principal direction of the camber.

The surface is deposited on the support in such a way that the camera can capture the whole of the surface in a single photograph, but no precise centering of the surface is necessary, nor any calibration or benchmarking step, thereby making it possible very advantageously to save time on an industrial line.

The present invention is now described with the aid of merely illustrative and wholly non-limiting examples of the scope of the invention, and on the basis of the appended illustrations, in which:

FIGS. 1a and 1b schematically illustrate the profile of a cambered surface in relation respectively to two perpendicular directions;

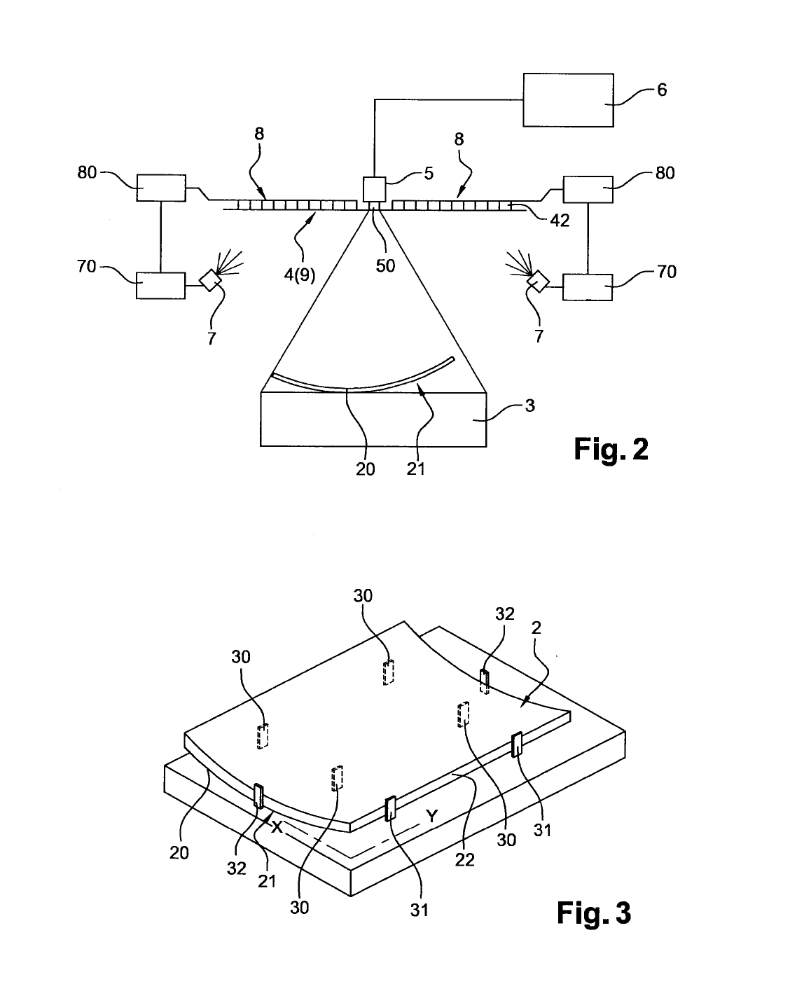

FIG. 2 represents a schematic sectional view of the measurement device of the invention, associated with a support carrying the surface to be measured;

FIG. 3 is a perspective view of the support of FIG. 2;

FIG. 4 is an end-on view of an example of first monodirectional-pattern gauge used by the device of the invention;

FIG. 5 is an end-on partial view of an example of a second gauge used by the invention.

FIG. 2 schematically illustrates the measurement device 1 of the invention for estimating the shape of a specular surface 2, such as one of the principal faces of a glazing with cambered shape exhibiting different curvatures in relation principally to two directions, the camber being more pronounced in relation to one of the directions.

The device comprises a support 3 on which the glazing is deposited and a more detailed view of which is illustrated in FIG. 3, a monodirectional-pattern gauge 4 which is more particularly illustrated with regard to FIG. 4, the surface 2 of the glazing facing the gauge, a camera 5, processing means 6 linked to the camera and able to process the photographs recorded by the camera, first means 7 of lighting of the gauge, and additional means of lighting 8 implemented when the first lighting means are turned off. The additional lighting means 8 are configured and designed to illuminate in the plane of the gauge in the direction of the surface to be measured 2 by producing a second gauge 9 with monodirectional pattern perpendicular to the pattern of the first gauge.

The device of the invention makes it possible by virtue of the first gauge 4 to produce an image in the surface at high resolution, and via the second gauge which is concealed in the first when the additional lighting means are turned off, to create an image of lower resolution but which is sufficient for the requirements in terms of measurement results. The modification of the conditions of lighting and of photograph capture by the camera ensure quasi-instantaneous switching from one gauge to the other and that two photographs are taken successively, one photograph per image of each of the gauges being reflected.

The measurement is therefore done in relation to two perpendicular directions, by considering that the most cambered shape must be measured with more precision than the least cambered shape, or else by considering that the knowledge of the shape in the second direction is negligible or that this shape is plane in this direction.

The support 3 with regard to FIGS. 3 and 4 forms a table with plane surface and on which are disposed several bearing pads 30, here visible by transparency through the surface and four in number, as well as lateral abutments 31 and 32. The cambered glazing is deposited on the support 3 according to one of its principal faces 20, opposite the surface 2 to be measured, the convex part 21 of the glazing being turned toward the support 3.

The glazing therefore rests via its face 20 on the bearing pads 30 which are appropriately spaced so as to suitably distribute the weight of the glazing in order to hold it in stable equilibrium. The lateral abutments 31 and 32 make it possible to wedge the glazing via its lateral rims 20 and 22.

The pads 30 and the abutments 31 and 32 also serve to correctly position the glazing, and consequently the surface 2, with respect to the gauge 4 which is intended to be reflected in this surface. The positioning of the glazing on the measurement support can be done by way of a robot arm. It can be done more simply by way of two operators. Much more commonly, the positioning of the glazing under the gauge is done while conveying the glazing on the line by stopping the glazing under the gauge, and then by focusing the glazing (by centering it) with the aid of removable rams playing the role of the abutments 31 and 32 associated with a lifting system ensuring a vertical up or down translation, and placed under the glazing instead of the bearing pads 30 so as to bring the glazing to the correct distance from the gauge. After the photographs are taken, the glazing is re-deposited on the conveyer and removed before the arrival of the following glazing. However, the positioning does not need to be extremely precise, it suffices that the image of the gauge is reflected on the whole of the surface and that the camera can capture the entirety of the surface in a single photograph.

The first gauge 4 illustrated in FIG. 4 is a gauge with monodirectional pattern forming a regular periodic signal. The gauge consists of a regular alternation of dark 40 and bright 41 lines or dashes, preferably of black and white lines so as to provide strong mutual contrast. The width of each line is constant, for example 10 mm.

Each line constitutes an object, optically speaking. Each line exhibits an upstream edge and a downstream edge whose positioning is taken as reference in the processing means 6. The camera 5 is intended to capture the image of the gauge in reflection on the surface, and consequently the image of each upstream and downstream edge of the lines; the processing means will establish a comparison of the positioning of the edges of each of the lines between the image and the reference, providing the optical magnification of each line. The processing method will be seen in greater detail subsequently.

The gauge 4 faces the surface 2 to be measured and is arranged some distance away. It extends according to a square or rectangular surface. The dimensions of the gauge and its distance of separation from the surface 2 are adapted so that the whole of the gauge can be reflected in the surface 2, these quantities taking account furthermore of the type of objective (angle of photograph capture) assigned to the camera. By way of example, for the shape measurement of a glazing of dimensions 1700×1600 mm, the gauge-surface distance is 2500 mm, and the dimensions of the gauge are 3600×1800 mm.

The objective 50 of the camera 5 (FIG. 2) is situated in the same plane as that of the gauge 4 and pointed in the direction of the surface 2. The type of objective and the distance to the surface permit full-field measurement, that is to say on the entirety of the surface in a single photograph.

The gauge 4 is for example supported by a white PVC rigid panel 42 on which are silk-screen-printed the black lines of identical width, regularly spaced.

The panel 42 comprises at its center an orifice 43 accommodating the objective of the camera. The orifice will be as small as possible since it will not be possible to measure the portion of the surface 2 facing it. In practice, to reckon the loss of measurement at the level of this observation zone as negligible, care will be taken to have a ratio of the area of the orifice to the area of the gauge of less than 1/1000. It will, however, be possible to artificially reconstruct the missing part of the gauge corresponding to this orifice via a suitable technique so as not to impair the measurement in this zone.

The gauge is illuminated via its front face (facing the surface 2) by virtue of the first lighting means 7, such as projectors. The lighting means are according to a number and an arrangement which are appropriate for providing homogeneous lighting of the whole of the gauge.

When the gauge 4 is illuminated by the first lighting means 7, the whole of its image reflecting in the specular surface 2 is intended to be photographed in a single capture by the camera which covers via its objective the whole of the area of the glazing.

The camera 5 is for example a matrix camera of known type comprising a decomposition of square pixels as 1700 columns by 1200 rows. Each pixel is associated with a precise zone of the image of the gauge taken as reference thereby making it possible to reference the position of each of the edges of lines of the gauge. Each pixel moreover corresponds to a zone (point) of the surface to be measured. The comparison between the gauge acquired either on a perfect glazing, or on a plane glazing and under geometric conditions of measurement that are identical to that of the glazing to be measured, and its image reflected by the glazing to be measured will make it possible to deduce the optical magnification of each of the lines at the level of each pixel and therefore of each point of the surface 2. By virtue of the processing means 6, the slope at each of the points and subsequently the altitude will be deduced from the measured optical magnification so as ultimately to establish the profile of the surface (its shape).

According to the invention, in order to have the best resolution for measuring the shape corresponding to the most pronounced concavity (principal direction), the glazing should be oriented with respect to the gauge in such a way that the lines of the gauge are disposed perpendicularly to this principal direction. Thus, with regard to FIG. 3, if the most pronounced concavity has principal direction X, the gauge 4 arranged opposite the surface 2 will be such that the lines 40 and 41 will be perpendicular to the axis X and parallel to the orthogonal axis Y. Using this gauge having a pattern of parallel lines corresponds to measuring the deformations observed in relation to the width of each of the lines, thereby ensuring a higher resolution of measurement than with the other type of gauge whose pattern will be seen further on, and is therefore suited to the profile of the most pronounced concavity.

The photographic capture of the image of the gauge and its processing to deduce the shape of the surface 2 according to the principal direction of the camber are performed in a very short time, of the order of 10 s.

According to the invention, the device makes it possible to measure extremely rapidly also, the shape corresponding to the secondary direction of the camber without moving the glazing.

According to the invention, a second gauge is therefore created according to a monodirectional pattern perpendicular to the pattern of the first gauge, the first then being as it were “erased” (no longer being visualized) so as to capture an image in reflection in the surface 2 of only the second gauge alone.

In order to no longer visualize the first gauge and create the second gauge, the additional lighting means 8 are provided and set into operation by control means 80, while the first lighting means 7 are turned off, commanded by control means 70. The control means 70 and 80 are driven in a common manner to ensure lighting up and concomitant turning off. It will also be possible in particular to adapt the exposure time of the camera to the luminous intensity of the second gauge, appreciably more luminous than the first gauge which is no longer illuminated so as “to erase” this first gauge still more effectively.

The additional lighting 8 is arranged at the level of the plane of the gauge, in the facade plane specifically of the gauge or in its immediate proximity. Furthermore, this lighting is situated in the space of the dark lines of the first monodirectional gauge 4.

By way of example, the additional lighting means 8 consist, with regard to FIG. 5, of a plurality of luminous points spaced regularly along each of the dark lines 41 of the gauge 4 forming the second gauge 9. These additional lighting means consist for example of a multiplicity of point light sources 90, such as light-emitting diodes or optical fiber terminations.

The pattern thus created of the second gauge produces a multitude of objects, formed optically speaking by the width of separation between two consecutive luminous points for each of the lines. This second gauge, once reflected in the surface 2, returns an image for which is measured, in the direction parallel to the secondary direction, the deformation (optical magnification), if any, of the distance of separation from one luminous point to another. This gauge 9 makes it possible to measure the shape in the secondary direction of the camber, that is to say in the Y direction. Such a pattern of the gauge, because of its lower resolution than that of the pattern of the first, is indeed used for the least cambered profile of the surface.

In the measurement method, once the camera 5 has taken a photograph of the first illuminated gauge 4, the first lighting means 7 are turned off while the additional lighting means 8 are turned on. The camera then takes another photograph of the surface 2 in which the second monodirectional gauge 9 is reflected, ensuring shape measurement in the secondary direction of the camber.

The processing and calculation means 6 are connected to the camera 5 to handle the mathematical processing operations and analyses which follow the two photographic captures.

The processing method consists, on the basis of the optical magnification measured γᵢ at a point of the surface (corresponding to the pixel i of the camera), and knowing the gauge-surface distance dₛₘ to be measured, in calculating the focal length fᵢ′ of the equivalent spherical mirror which would give a magnification γi of the gauge at the distance dₛₘ.

The following mathematical relation provides the calculation of the focal length fᵢ′ at the point associated with the pixel i:

fᵢ′=γᵢ·dₛₘ/(1−γᵢ) for an image in reflection.

It should be noted that this relation which involves only the easily measurable surface-gauge distance dₛₘ affords direct access to the focal length at any point of the mirror associated with each of the pixels of the camera. This measurement scheme is therefore absolute, that is to say it does not require any prior calibration, nor does it involve any camera sensitivity coefficient. Only the geometry of the optical setup needs to be ascertained, this posing no problem. This measurement scheme ensures very high industrial robustness for the device.

On the basis of the focal length calculated at each point, it is possible to deduce therefrom in a known way the local curvature (at each point), and then by integrating the local curvature a first time, the local slope is deduced therefrom, thereby affording access, after another mathematical integration, to the altitude of each of the points of the surface, and consequently to the shape of this surface.

The device of the invention thus provides, via its two very rapidly alternately visualizable monodirectional gauges, via the photographing of only two images, and via an easy calculation scheme, an extremely fast, reproducible measurement system requiring only a brief glazing stoppage time (of at most 10 seconds) followed by a processing time of at most 10 seconds when the glazing is advancing along an industrial line.

1-15. (canceled)

16: A device for measuring a shape of a mirror or of a specular surface, comprising:
a first monodirectional-pattern plane gauge configured to be some distance from a surface to be measured;
a camera for photographing an image to be reflected in the surface to be measured;
means for processing information recorded by the camera;
first means for lighting a whole gauge; and
additional lighting means arranged in immediate proximity and parallel to the plane of the gauge, or in an actual plane of the gauge, and facing the surface to be measured, the first lighting means and additional lighting means illuminating alternately so as to view respectively only the first gauge or else a second monodirectional-pattern gauge produced on the basis of the additional lighting means.

17: The device as claimed in claim 16, wherein a lighting time, respectively of the first lighting means and of the additional lighting means, lasts for a time required by the camera to take a respective photograph of an entirety of the surface.

18: The device as claimed in claim 16, wherein the first gauge comprises an alternation of dark and bright parallel lines of identical width, or of 10 mm in width.

19: The device as claimed in claim 18, wherein the second gauge provided by the additional lighting means comprises a multiplicity of point light sources, of a light-emitting diode or optical fiber termination type, which are regularly spaced according to an alignment parallel to the lines of the first gauge.

20: The device as claimed in claim 19, wherein the light sources are aligned in a manner centered in the width of at least one dark line.

21: The device as claimed in claim 16, further comprising a panel carrying the first gauge, the panel comprising a central orifice that accommodates an objective of the camera, or the orifice being dimensioned so that a ratio of its area to total area of the gauge is less than 1/1000.

22: The device as claimed in claim 16, wherein a distance between the first gauge and the surface to be measured, and dimensions of the gauge, are such that a whole of the gauge is reflected on an entirety of the surface to be measured, and an objective of the camera records in a single photograph the entirety of the surface to be measured.

23: The device as claimed in claim 16, associated with a plane support carrying the surface to be measured, the support extending parallel to the first gauge, and the surface to be measured configured to be arranged in a centered manner with respect to an optical axis of an objective of the camera.

24: The device as claimed in claim 23, wherein the surface to be measured is cambered, and its concavity is directed toward the gauge, and it is intended to be arranged on the support such that a monodirectional pattern of the first gauge is oriented perpendicularly to a principal direction of the camber.

25: The device as claimed in claim 16, applied to shape measurement of a glazing comprising a curved surface or of a parabolic solar mirror.

26: A method for measuring a shape of a mirror or of a specular surface having a concavity which is strongly marked in relation to a principal direction and less marked in relation to a secondary direction perpendicular to the principal direction, the method comprising an alternated lighting alternately revealing:
a first gauge with a monodirectional pattern perpendicular to the principal direction for measuring the shape in the principal direction, by a first lighting means, and
a second gauge with monodirectional pattern and perpendicular to the pattern of the first gauge for measuring the shape in the secondary direction, by a second lighting means, the first lighting means being turned off;
wherein the second lighting means illuminates through dark zones of the first gauge and produces the pattern of the second gauge.

27: The method as claimed in claim 26, wherein the second gauge is concealed in the first gauge when the first lighting means is turned on and the second lighting means is turned off.

28: The method as claimed in claim 26, wherein the first lighting means illuminates a front face of a first gauge, the second lighting means illuminating through the first gauge from a rear of the first gauge.

29: The method as claimed in claim 26, wherein the pattern of the second gauge comprises luminous points arranged in rows perpendicular to the secondary direction, the pattern of the first gauge comprises alternated dark and bright lines and pointlike patterns of the second gauge appearing in the dark lines.

30: The method as claimed in claim 26, wherein, during respective exposures, luminous intensity of the second gauge is greater than that of the first gauge.
